(19) United States
(12) Patent Application Publication
(10) Pub. No.: US 2010/0269358 A1
(43) Pub. Date: Oct. 28, 2010

(54) FLOWERKNIFE

(76) Inventor: Stig Rath, Saltnes (NO)

Correspondence Address: Stig Rath, Kloefteneveien 13, Saltnes, 1642, omitted

(21) Appl. No.: 12/710,434

(22) Filed: Feb. 23, 2010

(30) Foreign Application Priority Data
Apr. 22, 2009 (NO) 20091615
Nov. 19, 2009 (DE) 20 2009 015 580.3

(51) Int. Cl. A01G 3/00

(52) U.S. Cl. 30/295

(57) ABSTRACT

A knife specially designed to trim flower stems at the correct oblique angle allowing the user to apply full force behind the blade while protecting the thumb. The invention comprises a knife with thumb rest in which an extension of the knife blade is equipped with a resting surface for the thumb.

### CROSS-REFERENCE TO RELATED APPLICATIONS

Previous known publications of closely related technology are:
D1: FR 2874478 A1
D2: DE 19637080 A1
D3: WO 2007038920 A1
   D1 is considered to represent the known technology that is closest to the subject of the present application. D1 shows a knife for cutting flower stems, which comprises a blade and a handle, with one side of the knife blade being sharp. Publication D1 does not show a knife blade for cutting flower stems at an angle, in which a surface for the thumb is placed in an extension of the knife blade, as is the case in independent claim 1.

### BACKGROUND OF THE INVENTION

When cutting flower stems at an angle, it is important to have a knife that is as sharp as possible.

Because it is practical to hold the flower with the stem inwards, which also gives good view and control, flower arrangers and private persons cut the flower stems in a movement with the knife blade turning towards the body.

In order to obtain good control with the cut they move their grip as close to the knife blade as possible, so as to have good control and the best transfer of power when the blade is pushed through the stem.

When cutting is carried out in this way, the thumb often swings freely in front of the blade, with a consequent risk of cutting injury. This risk and fear for injuries is the background for inventing a knife specially for cutting flower stems.

### BRIEF SUMMARY OF THE INVENTION

The invention is based on a normal knife, but at the end of the knife blade there is a surface that the thumb can rest on. This will hereinafter be called a thumb rest. By equipping the knife with a thumb rest, good protection for the thumb is achieved when cutting the flower stem.

At the same time, the user is better able to apply the force needed to cut the stem, in that the hand will transfer power more directly to the knife blade instead of to the handle beside it.

The invention comprises a knife with thumb rest for use when cutting, especially at an angle, flower stems and other comparable cutting operations with a knife.

### BRIEF DESCRIPTION OF THE SEVERAL VIEWS OF THE DRAWING

The drawing show a diagonal-cutting knife, only for cutting flower stems, and particularly for diagonally cutting rose stems, characterized by having a resting surface (1) for the thumb placed on an extension of the knife blade (2).

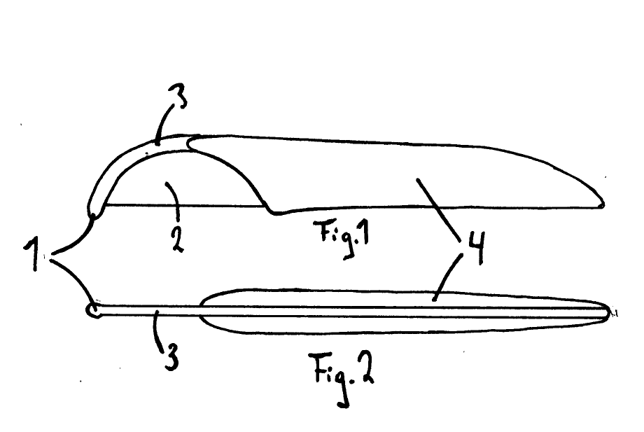

The knife with thumb rest (1) is shown on the drawing, where FIG. 1 is a side view of the knife and FIG. 2 shows the knife seen from above.

The knife blade (2) and knife back (3) may be made of metal or ceramic material, with a handle (4) of plastic, rubber or wood. The blade (2) shall be sharp and may be fixed to the handle in various ways.

The figures show a knife with a fixed blade and a tang into the handle.

### DETAILED DESCRIPTION OF THE INVENTION

The invention comprises a knife (2-3-4) with thumb rest (1) in which an extension of the knife blade (2) is equipped with a resting surface for the thumb. Traditional knives does not have this facility. By equipping the knife with a thumb rest, good protection for the thumb is achieved when cutting the flower stem.

At the same time, the user is better able to apply the force needed to cut the stem, in that the hand will transfer power more directly to the knife blade instead of to the handle beside it.

When cutting is carried out in this way, the thumb is placed safely to the side of the sharp blade, which minimize the risk of cutting injury. This risk and fear for injuries is the background for the invention.

1. A diagonal-cutting knife, only for cutting flower stems, and particularly for diagonally cutting rose stems, characterized by having a resting surface (1) for the thumb placed on an extension of the knife blade (2). The invention may have various designs and executions, and all combinations of knives that incorporate a thumb rest are therefore included in the patent claim.
